(19) United States
(12) Patent Application Publication
(10) Pub. No.: US 2008/0198744 A1
(43) Pub. Date: Aug. 21, 2008

(54) ACCESS CONTROL FOR PACKET-ORIENTED NETWORKS

(75) Inventor: Michael Menth, Oellingen (DE)

Correspondence Address: BELL, BOYD & LLOYD, LLP, P.O. BOX 1135, CHICAGO, IL, 60690, US

(73) Assignee: Siemens Aktiengesellschaft, Muenchen (DE)

(21) Appl. No.: 12/111,681

(22) Filed: Apr. 29, 2008

Related U.S. Application Data
(63) Continuation of application No. 10/524,524, filed on Feb. 11, 2005.

(30) Foreign Application Priority Data
Aug. 14, 2002 (DE) 10237334.5

(51) Int. Cl. H04L 12/26

(52) U.S. Cl. 370/230.1

(57) ABSTRACT

The invention relates to a method for access control to a packet-oriented network. An admissibility check for a group of packets is carried out by means of a threshold value for the traffic volume between the network input node and the network output node for the flow. The transmission of the groups of data packets is not permitted when an authorisation of the transmission would lead to traffic volume exceeding the threshold value. A relationship between the threshold values and the traffic volume in partials stretches or links may be formulated by means of the proportional traffic volume over the individual partial stretches. Using the capacities of the links the threshold values for pairs of input and output nodes can be fixed such that no overload occurs on the individual links. Within the above method a flexible reaction to the drop-out of links can be achieved by means of a resetting of the threshold values. Furthermore the inclusion of other conditions is possible, for example relating to the capacity of interfaces to other networks or special demands on transmission of prioritised traffic.

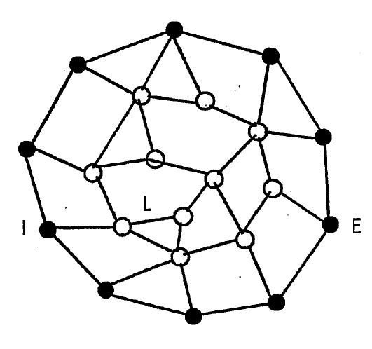

### CROSS REFERENCE TO RELATED APPLICATIONS

This application is the US National Stage of International Application No. PCT/DE2003/002736, filed Aug. 14, 2003 and claims the benefit thereof. The International Application claims the benefits of German application No. 10237334.5 filed Aug. 14, 2002, both applications are incorporated by reference herein in their entirety.

### FIELD OF THE INVENTION

The invention relates to a method for limiting traffic in a packet-oriented network.

### BACKGROUND OF THE INVENTION

The development of technologies for packet-based networks is currently a central field of activity for engineers from the fields of network engineering, switching systems and Internet technologies.

The primary objective of this activity is to be able to use a packet-oriented network ideally for any services. Traditionally, non-time-critical data transmissions are performed via packet-oriented networks, including, for example, the transfer of files or electronic mail. Voice transmission with real-time requirements is traditionally handled over telephone networks with the aid of time division multiplexing technology. Reference is often made also to TDM (Time Division Multiplexing) networks in this connection. With the laying of networks providing high bandwidth and/or transmission capacity, the implementation of image-related services has moved into the realm of the feasible along with data and voice transmission. Transmission of video information in real time, for example within the framework of video-Qn-demand services or videoconferences, will be an important category of services of future networks..

Development efforts are directed at enabling all services, data related, voice related and video information related, to be provided as far as possible over a packet-oriented network. Classes of service are typically defined in order to cater for the different requirements for data transmission in the context of the different services. Transmission at a defined quality of service (QoS) level, above all for services with real-time requirements, demands an appropriate means of management or control for handling the packet transmission over the network. There are number of terms in circulation that relate to the monitoring and/or control of traffic: traffic management, traffic conditioning, traffic shaping, traffic engineering, policing, etc. Various approaches to monitoring and/or controlling the traffic in a packet-oriented network are described in the relevant literature.

With ATM (Asynchronous Transfer Mode) networks, a reservation is made for every data transmission over the entire transmission link. The traffic volume is limited by the reservation. A section-by-section overload check is performed for monitoring purposes. Packets are possibly discarded depending on the CLP bit (CLP: Cell Loss Priority) of the packet header.

The Diff-Serv concept is used in IP (Internet Protocol) networks and is intended to provide a better quality of service for services with high quality requirements through introduction of classes of service. Reference is often made in this connection also to a CoS (Class of Service) model. The Diff-Serv concept is described in the RFCs with the numbers 2474 and 2475 published by the IETF. Under the Diff-Serv concept, the packet traffic is prioritized with the aid of a DS (Differentiated Services) field contained in the IP header of the data packets by setting of the DSCP (DS Code Point) parameter. Said prioritization is performed with the aid of “per hop” resource allocation, that is to say that the packets are subjected to a different treatment at the nodes in accordance with the class of service specified by means of the DSCP parameter in the DS field. The monitoring and/or control of the traffic is therefore carried out in accordance with the classes of service. The Diff-Serv concept leads to a privileged handling of the traffic of prioritized classes of service, but not to reliable control of the traffic volume.

Another approach to transmission over IP networks in relation to a quality of service is provided by the RSVP (resource reservation protocol). This protocol is a reservation protocol by means of which a bandwidth reservation is made along a path. A quality of service (QoS) transmission can then take place via this path. The RSVP protocol is used in combination with the MPLS (Multi Protocol Label Switching) protocol, which enables virtual paths over IP networks. The traffic volume is usually monitored and if necessary restricted along the path in order to guarantee the QoS transmission. As a result of the introduction of paths, however, much of the original flexibility of IP networks is lost.

Central to guarantees of transmission quality parameters is an efficient means of controlling the traffic. In the case of control of the traffic volume in the context of data transmission over packet-oriented networks, attention must also be given to assuring a high degree of flexibility and a low degree of complexity in the data transmission, as exhibited to a great extent, for example, by IP networks. However, said flexibility or, as the case may be, lack of complexity is lost again to a large extent when the RSVP protocol is used with an end-to-end path reservation. Other methods such as Diff-Serv lead to no guaranteed classes of service.

### SUMMARY OF THE INVENTION

The object of the invention is to specify an efficient method of traffic control for a packet-oriented network which avoids the disadvantages of traditional methods.

The object is achieved by the claims.

As part of the method according to the invention, an admissibility check is performed for a group of data packets of a flow that are to be transmitted over the network. The admissibility check is performed on the basis of a threshold value for the traffic volume between the network ingress node and the network egress node of the flow. The transmission of the group of data packets is not permitted if allowing the transmission would lead to a traffic volume that exceeds the threshold value.

The packet-oriented network can also be a part of a network or a subnetwork. In IP (Internet Protocol) systems there are, for example, network architectures in which the overall network is subdivided into networks called “autonomous systems”. The network according to the invention can be, for example, an autonomous system or the part of the overall network located in the area of competence (home location area) of a service provider (e.g. ISP: Internet Service Provider). In the case of a subnetwork, service parameters for a transmission over the overall network can be specified via a traffic control means in the subnetworks and an efficient means of communication between the subnetworks.

The term “flow” is usually used to designate the traffic between a source and a destination. In this context flow refers to the ingress node and the egress node of the packet-oriented network, that is to say that all the packets of a flow, in the sense in which we employ the term, are transmitted via the same ingress node and the same egress node. The group of packets is assigned for example to a connection (in the case of a TCP/IP transmission, defined by IP address and port number of egress and target process) and/or to a class of service.

Ingress nodes of the packet-oriented network are nodes via which the packets are routed into the network; egress nodes are nodes of the network via which the packets exit the network. Ingress nodes and egress nodes are terms often used in the literature to describe the nodes for entering and exiting the network respectively. For example, there can be a network which comprises edge nodes and internal nodes. If, for example, packets can enter the network or leave the network via all edge nodes of the network, the edge nodes of the network would in this case be both network ingress nodes and network egress nodes.

An admissibility test according to the invention can be performed by a control instance in a node or by front-end computers installed ahead of the nodes. In this arrangement one control instance can handle control functions for a plurality of nodes.

The traffic volume between a network ingress node and a network egress node is controlled by means of the admissibility check according to the invention. A growth in traffic volume between the two nodes that would lead to an overload in the network and consequently to delays and the discarding of packets can be prevented. The limiting of the traffic volume can be carried out along the lines of a transmission with negotiated quality of service features (SLA: Service Level Agreements) based, for example, on the prioritization of the traffic.

In order to provide a guarantee for services with QoS data transmission it can be important to control the entire traffic volume within the network. This goal can be achieved in that, for all pairs of network ingress nodes and network egress nodes, threshold values are laid down for the traffic volume between each node pair. The threshold values for the traffic volume between pairs of network ingress nodes and network egress nodes can be placed in relation to values for the maximum traffic volume on links. In this case the maximum value for the traffic volume on links will generally be based not only on the bandwidth, but also on the network technology used. For example, it will usually need to be considered whether the network is a LAN (Local Area Network), a MAN (Metropolitan Area Network), a WAN (Wide Area Network) or a backbone network. Other parameters than the transmission capacity such as, for example, delays in the transmission must be taken into account in addition, for example, for networks for real-time applications. For example, a utilization level close to 100% for LANs with CSMA/CD (Carrier Sense Multiple Access (with) Collision Detection) is associated with delays which usually rule out real-time applications. The threshold values for the traffic volume between pairs of network ingress nodes and network egress nodes can then be specified from the maximum values for the maximum traffic volume on links. In the preferred embodiment this relation is based on the proportional traffic volume for the pairs of network ingress nodes and network egress nodes over the individual links of the network. The proportional traffic volume for the pairs of network ingress nodes and network egress nodes over the individual links of the network can be determined on the basis of empirical values or known characteristics of nodes and links. It is also possible to carry out measurements on the network in order to obtain the proportional traffic volume over the individual links as a function of network ingress nodes and network egress nodes. In traffic theory reference is made in this connection to the traffic matrix.

The invention has the advantage that information for access control only has to be held at ingress nodes. For an ingress node this information comprises, for example, the threshold values and current values for the traffic volume between the ingress node and the different egress nodes. The scope of the information is limited. Updating the traffic volume requires little overhead. The internal nodes do not need to take on any functions with regard to the admissibility check. The method is therefore substantially more economical in terms of overhead and has a lower level of complexity than methods which provide admissibility checks for individual links. In contrast to traditional methods such as ATM or MPLS, no path needs to be reserved within the network.

In a variant of the method according to the invention, two further admissibility checks are performed in addition, with one of these admissibility checks being performed on the basis of a threshold value for the traffic routed via the network ingress node of the flow and the other on the basis of a threshold value for the traffic routed via the network egress node of the flow. The admissibility check performed on the basis of a threshold value for the traffic routed via the network egress node of the flow can be carried out for example at the corresponding egress node. The control instances for the individual admissibility checks then communicate with one another in order to arrive at a decision relating to the transmission of the group of data packets based on the results of the individual admissibility checks.

Within the framework of this variant a relation can be established between the traffic volume between pairs of network ingress nodes and network egress nodes and the traffic volume on links of the network. By means of the values for a maximum traffic volume on the links of the network, limits can be determined for the traffic volume between the pairs of network ingress nodes and network egress nodes as well as threshold values for the traffic routed via the network ingress nodes and for the traffic routed via the network egress nodes.

The relation between the traffic volume between pairs of network ingress nodes and network egress nodes and the traffic volume on links of the network can be established as an optimization problem with supplementary conditions and/or auxiliary conditions in the form of inequalities. In this case the proportional traffic volume over the individual links of the network is factored into the calculation in order to formulate the relation between the traffic volumes between pairs of network ingress nodes and network egress nodes and the traffic volume on links of the network.

Said formulation also permits further criteria in the form of inequalities to be incorporated into the determination of the limits or, as the case may be, threshold values for the admissibility checks. Conditions in the form of inequalities can, for example, be included in the determination of limits or, as the case may be, threshold values for the admissibility checks, which conditions necessitate a low traffic volume of high-priority traffic on links with comparatively long delay times. Another example is that of an egress node via which packets can be transmitted to a plurality of ingress nodes of other networks; in other words, the egress node has interfaces to a plurality of other networks. If an ingress node of one of the following networks can process a smaller data volume than the egress node, it can be ensured by means of a further auxiliary condition in the form of an inequality that the traffic routed via the egress node to the ingress node exceeds the latter's capacity.

According to a development of the invention, if a link drops out the limits or, as the case may be, threshold values for the admissibility check or admissibility checks are reset with the condition that no packets are transmitted via the failed link. By means of the new specification of the limits it is achieved that the traffic that would otherwise have been transmitted via the failed link is routed via other links without an overload occurring as a result of the redirected traffic. In this way a flexible response to failures can be implemented.

Precautionary protection against link dropouts can be ensured by the choice of the threshold values or limits. In this case limits or threshold values are determined for each of a plurality of possible problem situations, which limits or threshold values cause the traffic volume to remain within an admissible framework even in a problem situation, in other words parameters such as propagation time delay and packet loss rate remain within ranges defined by the quality requirements for the data transmission. The limits or threshold values are then set to the minimum of the values for the problem situations under investigation. In other words, each of the problem situations is intercepted by the choice of the limits or threshold values. The plurality of problem situations can for example include all dropouts of links.

The cited admissibility checks can also be performed as a function of the class of service. It is conceivable, for example, to have a low-priority class of service in which delays or the discarding of packets are tolerated when the utilization of the network is high. Conversely, the limits for high-priority traffic would be chosen such that guarantees with regard to transmission quality parameters can be accepted.

The invention will be explained in more detail below with reference to a figure within the framework of an exemplary embodiment.

### BRIEF DESCRIPTION OF THE DRAWING

The sole FIGURE shows a network according to the invention.

### DETAILED DESCRIPTION OF THE INVENTION

The FIGURE shows a network according to the invention. Edge nodes are identified by solid circles, internal nodes by empty circles. Links are represented by connecting lines between the nodes. By way of example, an ingress node is identified by I, an egress node by E, and a link by L. Some of the traffic between the nodes I and E is transmitted via the link L. The admissibility checks at the ingress node I and possibly at the egress node E ensure, in combination with the other admissibility checks, that no overload occurs on the link L.

Mathematical relations for the method according to the invention are presented in the following. In practice, limits or threshold values are usually defined as a function of the maximum link capacities. In the interests of easier mathematical presentation, the reverse case is considered below, i.e. the dimensioning of the links is calculated as a function of the limits or threshold values. The solution of the reverse problem can then be arrived at by means of numerical methods.

The following variables will be introduced for the detailed description below:
BBB(i,j): the limit for the traffic volume between the ingress node i and the egress node j
c(L): the traffic volume on the network link L
aV(i,j,L): the proportional traffic volume via the link L of the total traffic volume between the ingress node i and the egress node j

The following is true for each link L:

C(L)=ΣBBB(i,j)·aV(i,j,L), (1)

where the total runs via all network ingress nodes i and network egress nodes j. This applies on the assumption that no packets of the network are routed in a circle. In other words, the transmission inside the network is free of loops. By means of the equation (1) a relation is established by means of which the parameters c(L) are placed in relation to the limits BBB(i,j).

The following mathematical relation can be formulated for the embodiment with two additional admissibility checks. The above definitions hold true. In addition let the following be assumed
Ingress(i): the threshold value for the traffic via the network ingress node i,
Egress(j):the threshold value for the traffic via the egress node j,
δ(i,j): the traffic volume between the network ingress node i and the network egress node j.

The following inequalities can now be formulated:
The following applies to all i:

Σδ(i,j)≦Ingress(i), total of all j. (2)
The following applies to all j:

Σδ(i,j)≦Egress(j), total of all i. (3)

The following applies to all 2-tuples (i,j)

δ(i,j)≦BBB(i,j). (4)
The following applies to all links L:

c(L)=Σδ(i,j)·aV(i,j,L), total of all i and j. (5)

The simplex algorithm can be used to calculate, for predefined values of Ingress(i), Egress(j) and BBB(i,j), the maximum c(L) which satisfy the inequalities (2) to (4). Conversely, it can be verified for a set of limits or threshold values Ingress(i), Egress(j) and BBB(i,j) whether an inadmissibly high load can occur on a link L. In this case the limits or threshold values can be changed to counteract the too high load.

The inventive method allows a response to be made to problems in a simple manner, by modification of the limits or threshold values. Thus, for example, if a link L drops out, the relation can exclude this link (by setting all aV(i,j,L) for this link L to zero, for example). As a result of the new formulation of the relation, revised limits or threshold values can be determined which, as admissibility criteria, prevent overloads occurring in the network.

1.-11. (canceled)

12. A method for limiting traffic in a packet-oriented network having a plurality of links, the method comprising:
performing an admissibility check for a group of data packets of a flow to be transmitted via the network, wherein
the admissibility check is performed on the basis of a threshold value for the traffic volume between the network ingress node and the network egress node of the flow, and wherein the transmission of the group of data packets is not allowed if an authorization of the transmission would lead to a traffic volume exceeding the threshold value.

13. The method as claimed in claim 12, wherein for all pairs of network ingress nodes and network egress nodes threshold values are defined for the traffic volume between each node pair.

14. The method as claimed in claim 13, wherein the threshold values for the traffic volume between pairs of network ingress nodes and network egress nodes are placed in relation to the traffic volume on the links of the network, and wherein the threshold values for the traffic volume between network ingress nodes and network egress nodes are defined by means of values for maximum traffic volumes on the links of the network.

15. The method as claimed in claim 14, further comprising:
determining the proportional traffic volume over the individual links of the network for the pairs of network ingress nodes and network egress nodes; and
placing in relation the threshold values for the traffic volume between pairs of network ingress nodes and network egress nodes to the traffic volume on links of the network by using the values for the proportional traffic volume via the individual links.

16. The method as claimed in claim 12, wherein two further admissibility checks are performed, wherein one of these admissibility checks is performed using a threshold value for the traffic routed via the network ingress node of the flow, and wherein the other admissibility check is performed using a threshold value for the traffic routed via the network egress node of the flow.

17. The method as claimed in claim 16, further comprising:
establishing a relation between the traffic volumes between pairs of network ingress nodes and network egress nodes and the traffic volume on links of the network; and
determining limits for the traffic volume between the pairs of network ingress nodes and network egress nodes and determining threshold values for the traffic routed via the network ingress nodes and for the traffic routed via the network egress nodes by using values for a maximum traffic volume on the links of the network.

18. The method as claimed in claim 17, wherein
the relation between the traffic volumes between pairs of network ingress nodes and network egress nodes and the traffic volume on links of the network is established with the aid of inequalities, and
an optimization method is performed for the traffic volume on links of the network, wherein
the inequalities being used as auxiliary conditions for the optimization, and wherein
the proportional traffic volume over the individual links of the network being used for formulating the relation between the traffic volumes between pairs of network ingress nodes and network egress nodes and the traffic volume on links of the network.

19. The method as claimed in claim 12, wherein, if a link drops out, the limits or the threshold values for the admissibility check or admissibility checks are reset with the condition that no packets are transmitted via the failed link.

20. The method as claimed in claim 13, wherein, if a link drops out, the limits or the threshold values for the admissibility check or admissibility checks are reset with the condition that no packets are transmitted via the failed link.

21. The method as claimed in claim 14, wherein, if a link drops out, the limits or the threshold values for the admissibility check or admissibility checks are reset with the condition that no packets are transmitted via the failed link.

22. The method as claimed in claim 15, wherein, if a link drops out, the limits or the threshold values for the admissibility check or admissibility checks are reset with the condition that no packets are transmitted via the failed link.

23. The method as claimed in claim 16, wherein, if a link drops out, the limits or the threshold values for the admissibility check or admissibility checks are reset with the condition that no packets are transmitted via the failed link.

24. The method as claimed in claim 12, wherein limits or threshold values dependent on the class of service of the group of packets are used for at least one admissibility check.

25. The method as claimed in claim 13, wherein limits or threshold values dependent on the class of service of the group of packets are used for at least one admissibility check.

26. The method as claimed in claim 14, wherein limits or threshold values dependent on the class of service of the group of packets are used for at least one admissibility check.

27. The method as claimed in claim 15, wherein limits or threshold values dependent on the class of service of the group of packets are used for at least one admissibility check.

28. The method as claimed in claim 16, wherein limits or threshold values dependent on the class of service of the group of packets are used for at least one admissibility check.

29. The method as claimed in claim 12, further comprising:
determining limits or threshold values for each of a plurality of possible problem situations, which limits or threshold values cause the traffic volume to remain within an admissible framework even in a problem situation; and
setting the limits or threshold values to the minimum of the values for the problem situations under investigation.

30. The method as claimed in claim 13, further comprising:
determining limits or threshold values for each of a plurality of possible problem situations, which limits or threshold values cause the traffic volume to remain within an admissible framework even in a problem situation; and
setting the limits or threshold values to the minimum of the values for the problem situations under investigation.

31. The method as claimed in claim 18, wherein at least one further relation is established with the aid of an inequality, which relation expresses a traffic limitation on a link of the network or on a link leading away from the network, and the optimization method is performed using a condition regarding said further relation.
